(19) United States
(12) Patent Application Publication
(10) Pub. No.: US 2007/0133885 A1
(43) Pub. Date: Jun. 14, 2007

(54) Apparatus and method of detecting person

(75) Inventors: Jinguk Jeong, Yongin-si (KR); Youngsu Moon, Seoul (KR); Maolin Chen, Yongin-si (KR); Gengyu Ma, Yongin-si (KR); Jiyeun Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/638,395

(22) Filed: Dec. 14, 2006

(30) Foreign Application Priority Data
Dec. 14, 2005 (KR) 10-2005-0123158

(51) Int. Cl. G06K 9/62; G06K 9/00

(52) U.S. Cl. 382/228; 382/165

(57) ABSTRACT

An apparatus and method of detecting a person. The apparatus includes: a segmentation unit which analyzes plural pieces of color information of a plurality of pixels configuring a given image and generates at least one segment by grouping at least one of the pixels having a specified similarity among the plural pieces of color information; a hypothesis generating unit which initially selects a segment in each component of the given image according to an initial selection probability that a segment is initially selected, selects an additional segment in each component according to a connection probability that the additional segment is connected to a previously selected segment, and connects the selected additional segment to the previously selected segment; a hypothesis verifying unit which calculates a degree that a plurality of components formed by integrating the selected segments can be recognized as the person and determines that the plurality of the components is the person to be detected in response to the calculated result; and a segment probability updating unit which updates the initial selection probability and the connection probability in correspondence with the calculated degree.

### CROSS-REFERENCE TO RELATED APPLICATION

This application claims the benefit of Korean Patent Application No. 10-2005-0123158, filed on Dec. 14, 2005, in the Korean Intellectual Property Office, the disclosure of which is incorporated herein by reference.

### BACKGROUND OF THE INVENTION

1. Field of the Invention

The present invention relates to person detection, and more particularly, to more particularly, to an apparatus and method of detecting a person by calculating a degree that a plurality of components formed by integrating at least one segment selected according to an initial section probability and a connection probability can be recognized as a person, updating the initial selection probability and the connection probability in correspondence with the degree, and repeating the update.

2. Description of Related Art

Conventional methods of detecting a person from an image include a person-based detecting method, a component-based detecting method, and a segmentation-based detecting method.

In the person-based detecting method, a region in which a shape similar to a person model learned previously is positioned is detected as a person from an image. In this method, it is difficult to use previously learned information regarding various types of persons and to accurately detect the person.

In the component-based detecting method, a person to be detected is recognized by connecting a plurality of components such as a body component or head component and a region in which a shape similar to the component model learned previously is positioned is detected as a person from an image. In this method, it is impossible to detect the person when a physical portion corresponding to the component to be detected is not displayed well.

In the segmentation-based detecting method, it is assumed that at least one segment configures one component, and a region which a shape similar to a component composed of a combination of segments is positioned is detected as a person from an image. In this method, since the number of combinations is large, it is impossible to rapidly detect a person.

### BRIEF SUMMARY

An aspect of the present invention provides an apparatus for detecting a person by calculating a degree that a plurality of components formed by integrating at least one segment selected according to an initial section probability and a connection probability can be recognized as a person, updating the initial selection probability and the connection probability in correspondence with the degree, and repeating the update.

An aspect of the present invention also provides a method of detecting a person by calculating a degree that a plurality of components formed by integrating at least one segment selected according to an initial section probability and a connection probability can be recognized as a person, updating the initial selection probability and the connection probability in correspondence with the degree, and repeating the update.

According to an aspect of the present invention, there is provided an apparatus for detecting a person.

According to another aspect of the present invention, there is provided a method of detecting a person.

Operation (a) may include (a11) dividing the image into a plurality of sub images and specifying a pixel in each of the sub images; (a12) analyzing a similarity between color information of the specified pixel and color information of a pixel which is not specified and determining whether the analyzed similarity is greater than or equal to a reference value; (a13) allocating the pixel which is not specified to a segment containing the specified pixel if the analyzed similarity is greater than or equal to the reference value; (a14) calculating a similarity between color information of the at least one segment close to the segment and color information of the pixel which is not specified if the analyzed similarity is less than the reference value; and (a15) allocating the pixel which is not specified in the segment having a maximum similarity in (a14). Operations (a12) to (a15) may be performed on each of the sub images.

The initial selection probability may be determined in proportion to at least one of a dissimilarity between color information of the segment and color information of a background segment and a probability that the segment belongs to its component.

The connection probability may be determined in proportion to at least one of a similarity between color information of the additional segment and color information of the previously selected segment, a dissimilarity between color information of the additional segment and color information of a background segment, a probability that the additional segment is connected to the previously selected segment, and a probability that the additional segment belongs to its component.

Operations (b) and (c) may be performed N times (N being an integer greater than or equal to 2) in parallel. In operation (c), the degrees of N component models may be calculated, and, in operation (e), N initial selection probabilities and N connection probabilities may be updated in correspondence with the calculated results.

According to another aspect of the present invention, there is provided a computer-readable medium having embodied thereon a computer program for performing a method of detecting a person, the method including.

According to another aspect of the present invention, there is provided a method of detecting a person, the method including: analyzing color information of a plurality of pixels of a candidate region of a given image where a person is expected to be, groups pixels having a specified similarity, and generates at least one segment; a hypothesis generating unit generating a generated component model which can be detected as the person by initially selecting a segment in each component according to an initial selection probability, selecting a second segment in each component according to a connection probability that the second segment is connected to a previously selected segment, and connecting the second selected segment to the previously selected segment; calculating a degree that the generated component model can be recognized as the person and verifying whether the component model is the person to be detected in response to the calculated result; and updating unit updating the initial selection probability and the initial connection probability based on the verification result when the calculated degree is less than a specified threshold and returning to the segmenting.

According to other aspects of the present invention, there are provided computer-readable media having embodied thereon computer programs for performing the aforementioned methods.

Additional and/or other aspects and advantages of the present invention will be set forth in part in the description which follows and, in part, will be obvious from the description, or may be learned by practice of the invention

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating an apparatus for detecting a person according to an embodiment of the present invention;

FIG. 2 is a block diagram illustrating a segmentation unit 120 illustrated in FIG. 1;

FIGS. 3A to 3D are views explaining an operation of the segmentation unit 120 illustrated in FIG. 1;

FIG. 4 is a flowchart illustrating the operation of the segmentation unit 120 illustrated in FIG. 1;

FIG. 5 is a block diagram illustrating an example 140A of the hypothesis generating unit 140 illustrated in FIG. 1;

FIG. 6 is a view explaining an operation of the hypothesis generating unit 140 illustrated in FIG. 1;

FIG. 7 is a flowchart illustrating the operation of the hypothesis generating unit 140 illustrated in FIG. 1;

FIG. 8 is a block diagram illustrating an example 150A of the hypothesis verifying unit 150 illustrated in FIG. 1;

FIG. 9 is a view explaining an operation of the hypothesis verifying unit 150 illustrated in FIG. 1;

FIG. 10 is a flowchart illustrating the operation of the hypothesis verifying unit 150 illustrated in FIG. 1;

FIG. 11 is a block diagram illustrating an example 160 of the segment probability updating unit 160 illustrated in FIG. 1; and

FIG. 12 is a flowchart illustrating an operation of the segment probability updating unit 160 illustrated in FIG. 1.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

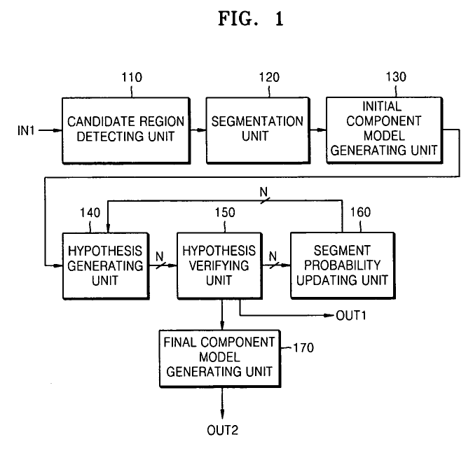

FIG. 1 is a block diagram illustrating an apparatus for detecting a person according to an embodiment of the present invention. The apparatus for detecting the person includes a candidate region detecting unit 110, a segmentation unit 120, an initial component model generating unit 130, a hypothesis generating unit 140, a hypothesis verifying unit 150, a segment probability updating unit 160, and a final component model generating unit 170.

The candidate region detecting unit 110 receives displayable image data through an input terminal IN1 and detects a candidate region from an image of the input image data. At this time, the image is a still image or an image of a frame at a specific point of time in a moving image.

Here, the candidate region represents a region in which it is expected that a person exists in the given image. A region of the image excluding the candidate region in the given image is referred to as a background region. The candidate detecting unit 110 may detect a region having a person's skin color in the given image as the candidate region.

The segmentation unit 120 analyzes color information of a plurality of pixels configuring the given image, groups pixels having a specified similarity among plural pieces of analyzed color information, and generates at least one segment.

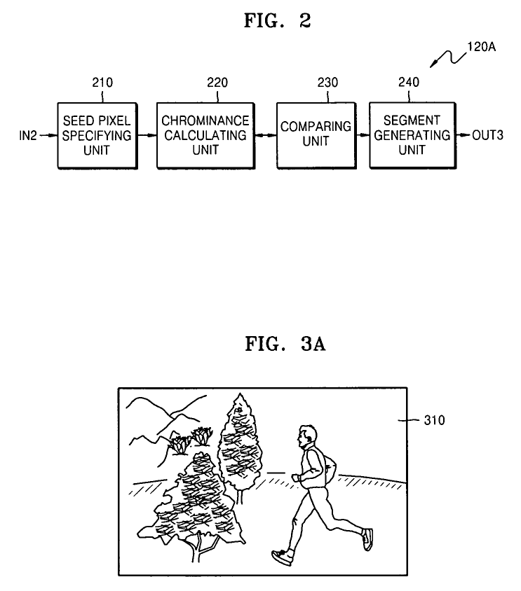

Here, the given image may include both the background region and the candidate region. The specified similarity may be previously set and changed later. The operation of the segmentation unit 120 will be described in detail with reference to FIGS. 2 to 4.

In the present embodiment, a person to be detected is recognized by a plurality of components formed by connecting and integrating at least one segment. Hereinafter, this component is referred to as a segment-based component. Here, the plurality of components includes, for example, a head component, a body component, an arm component, and a leg component.

The initial component model generating unit 130 generates an initial component model which can be detected as the person. Here, the component model may be composed of a plurality of components and each of the components is the segment-based component.

The initial component model has a relative position and a relative size of one component against another component, and an absolute position and an absolute size of one component are determined by the hypothesis generating unit 140.

The component model may be defined by three parameters such as Pc, Cc, and Tc. Here, Pc and Cc are defined for all the segments configuring the component, and Tc denotes the component model having the relative position and the relative size of one component against another component. Tc may be previously set.

The initial component model is defined by Pc, Cc, and Tc and the component model defined according to a hypothesis generated by the hypothesis generating unit 140 is defined by Pc, Cc, and the absolute position and the absolute size of one component according to the hypothesis.

Pc(r) defined for an r^{th} segment includes Pᵣₛ(r, rᵢ) and Pᵣₕ(r). Here, Pᵣₛ(r, rᵢ) and Pᵣₕ(r) can be calculated using Equation 1.

$${P}_{rs} ( r , {r}_{i} ) = \frac{1}{{ⅇ}^{{D}_{i}}} \\ {P}_{rh} ( r ) = {D}_{i} \qquad Equation 1$$

In Equation 1, Pᵣₛ(r, rᵢ) denotes a similarity between color information of the r^{th} segment and color information of an rᵢ^{th} segment, Pᵣₕ(r) denotes a dissimilarity between color information of the r^{th} segment and color information of a background segment, and Dᵢ denotes a difference between a representative pixel value of the r^{th} segment and a representative pixel value of the rᵢ^{th} segment.

The color information of the segment represents representative color information of the segment. For example, a mean pixel value of all the pixels contained in the segment may become the representative color information of the segment. In addition, the rᵢ^{th} segment may be a peripheral segment of the r^{th} segment and the background segment may be a segment which is closest to the r^{th} segment in the segments for configuring the background region or a segment which is optionally selected.

The parameter Cc defined for the r^{th} segment includes P_{rc}(r, rᵢ) and Pᵣₐ(r, C). Here, P_{rc}(r, rᵢ) denotes a probability that the r^{th} segment is connected to the rᵢ^{th} segment and Pᵣₐ(r, C) denotes a probability that the r^{th} segment belongs to a component C. Even in this case, the rᵢ^{th} segment may be a peripheral segment of the r^{th} segment.

In the initial segment model, the parameter Cc may be set to the same value with respect to all the segments. The hypothesis generated by the hypothesis generating unit 140 varies depending on the parameter Cc, and the parameter Cc is updated by the segment probability updating unit 160. As the update is repeated, at least one segment selected by the hypothesis generating unit 140 is integrated and thus a degree that the plurality of components can be recognized as the person increases.

The parameter Cc allows “optimal selection” and “optimal combination” to be performed in “number of cases in selection” and “number of cases in combination of the selected segments” when selecting the segments configuring the person from all the segments generated by the segmentation unit 120. Hereinafter, in the present specification, the parameter Cc denotes a segment probability.

An ants colony optimization (ACO) algorithm simulates a procedure that an ant uses to find food. In this procedure, an ant stains the ground with pheromone. Accordingly, the more the ant moves, the more the ground is stained with the pheromone. A path which is most stained with the pheromone may be an optimal path for finding the food and thus ants move along the path. Accordingly, since the pheromone allows the ant to move along the optimal path, the pheromone is a representative example for representing the segment probability of the present invention. In other words, the pheromone is an example for representing P_{rc}(r, rᵢ) or Pᵣₐ(r, C).

The parameter Tc denotes the component model having the relative position and the relative size of one component against another component. The position and the size of the one component may be relative to the position and size of the body component. Each component may be represented by the parameter Tc has an elliptical shape and is represented by a Gaussian model.

The hypothesis generating unit 140 initially selects a segment in each component according to an initial selection probability P, selects a segment in each component according to a connection probability Pc, and connects the selected segment to a previously selected segment.

the hypothesis generating unit 140 may first operate on the body component. For example, the hypothesis generating unit 140 may operate on the body component, the head component, the leg component, and the arm component in this order.

A initial selection probability P(k) that a k^{th} segment is initially selected as a segment configuring the component C can be calculated using Equation 2.

$$P ( k ) = \frac{{P}_{rh} ( k ) * {P}_{ra} ( k , C )}{Z} \qquad Equation 2$$

In Equation 2, Z denotes a normalization factor for preventing P(k) from exceeding 1. The component C may be the body component, the head component, the leg component, or the arm component.

A probability that an l^{th} segment is connected to an m^{th} segment as the segment configuring the component C can be calculated using Equation 3.

$$Pc ( l ) = \frac{{P}_{rh} ( l ) * {P}_{rs} ( l , m ) * {P}_{rc} ( l , m ) * {P}_{ra} ( l , C )}{Z} \qquad Equation 3$$

In Equation 3, Z denotes a normalization factor for preventing Pc(I) from exceeding 1. Similarly, the component C may be the body component, the head component, the leg component, or the arm component.

The hypothesis generating unit 140 generates a component model which can be detected as the person. In other words, the hypothesis generated by the hypothesis generating unit 140 represents the generated component model.

Here, the generated component model is composed of a plurality of components formed by integrating at least one segment selected according to the initial selection probability P and the connection probability Pc. Each of the components configuring the generated component model has an absolute position and an absolute size.

The hypothesis verifying unit 150 calculates a degree that the component model formed by integrating at least one segment can be recognized as the person and verifies whether the component model is the person to be detected in response to the calculated result.

In particular, the hypothesis verifying unit 150 calculates a degree that the component model can be recognized as the person and verifies whether the degree is greater than a specified value. If it is determined that the degree is greater than or equal to the specified value, the hypothesis verifying unit 150 determines the component model as the person to be detected. In this case, the hypothesis verifying unit 150 notifies a user that the component model is the person to be detected through an output terminal OUT1. Accordingly, the output terminal OUT1 may be connected to a display panel.

If it is determined that the degree is less than the specified value, the hypothesis verifying unit 150 operates the segment probability updating unit 160. The specified value may be previously set and may be changed later.

The segment probability updating unit 160 updates the initial selection probability P and the connection probability Pc in correspondence with the result verified by the hypothesis verifying unit 150. In other words, the segment probability updating unit 160 updates a current segment probability Cc.

In particular, the segment probability updating unit 160 may increase the initial selection probability P and the connection probability Pc in proportion to the degree calculated by the hypothesis verifying unit 150.

When the degree calculated by the hypothesis verifying unit 150 is greater than or equal to the specified value, the final component model generating unit 170 receives the component model generated by the hypothesis generating unit 140 and outputs the component model through an output terminal OUT2 as a final component model. The final component model represents a component model which is finally determined as the person to be detected.

The hypothesis generating unit 140, the hypothesis verifying unit 150, and the segment probability updating unit 160 may operate N times (N is an integer greater than or equal to 2) in parallel. For example, the apparatus for detecting the person according to the present embodiment includes N agents, which operate in parallel. Each agent operates the hypothesis generating unit 140, the hypothesis verifying unit 150, and the segment probability updating unit 160.

In this case, the hypothesis generating unit 140 generates N component models through N parallel operations, and the hypothesis verifying unit 150 verifies the degree that the component model can be recognized as the person in the N component models. In addition, the segment probability updating unit 160 updates N initial selection probabilities P and N connection probabilities Pc in correspondence with the result verified by the hypothesis verifying unit 150.

FIG. 2 is a block diagram illustrating an example 120A of the segmentation unit 120 illustrated in FIG. 1. The segmentation unit 120A includes a seed pixel specifying unit 210, a chrominance calculating unit 220, a comparing unit 230, and a segment generating unit 240.

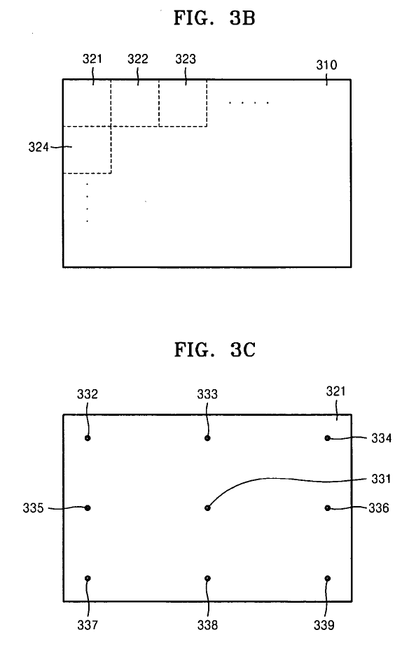

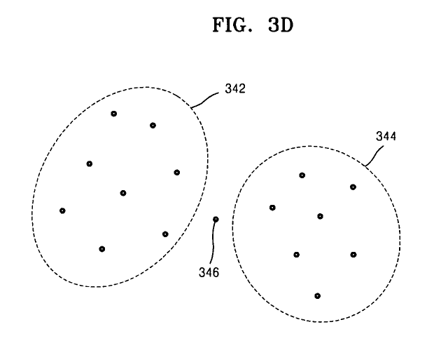

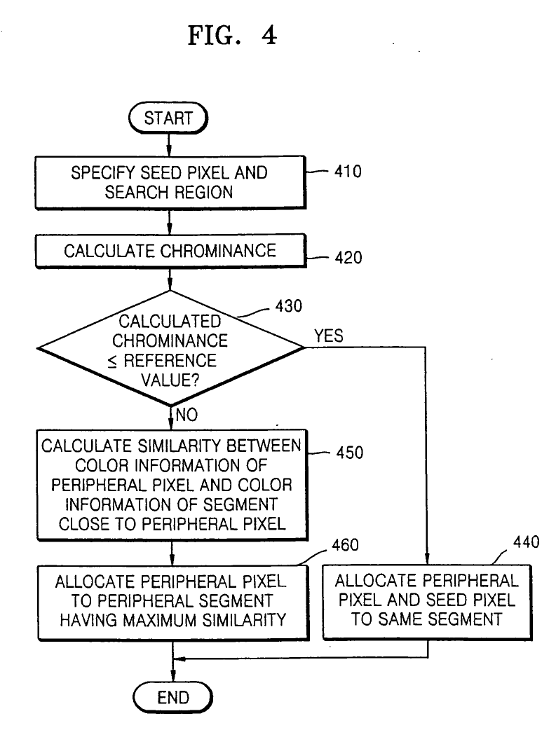

FIG. 3A to 3D are views explaining an operation of the segmentation unit 120 illustrated in FIG. 1 and FIG. 4 is a flowchart illustrating the operation of the segmentation unit 120 illustrated in FIG. 1.

The operation of the segmentation unit 120 will be described in detail with reference to FIGS.2 to 4.

The seed pixel specifying unit 210 divides an image 310 input through an input terminal IN2 into a plurality of sub images 321, 322, 323, 324, . . . and specifies one pixel in each sub image as a seed pixel (operation 410). The image 310 may include both the background region and the candidate region.

The pixels except the seed pixel in each sub image are referred to as peripheral pixels. A region occupied by each of the sub images 321, 322, 323, 324, . . . is referred to as a search region.

For example, the seed pixel specifying unit 210 selects one pixel 331 from all the pixels 331, 332, . . . , 339 contained in the sub image 321 as the seed pixel. At this time, it is preferable that the seed pixel specifying unit 210 specifies a pixel in the vicinity of the center of the sub image 321 as the seed pixel.

The seed pixel specifying unit 210, the chrominance calculating unit 220, the comparing unit 230, and the segment generating unit 240 operate on all the sub images.

The chrominance calculating unit 220 analyzes a similarity between color information of the pixel specified by the seed pixel specifying unit 210 and color information of a pixel which is not specified by the seed pixel specifying unit 210 (i.e., a peripheral pixel) (operation 420). For example, the chrominance calculating unit 220 calculates a difference between the pixel value of the seed pixel 331 and the pixel value of the peripheral pixel 332, 333, 334, . . . or 339. The difference between the pixel values is referred to as chrominance.

The comparing unit 230 compares the similarity analyzed by the chrominance calculating unit 220 with a reference value set previously and determines whether the analyzed similarity is greater than or equal to the reference value (operation 430). For example, the comparing unit 230 compares the chrominance calculated by the chrominance calculating unit 220 with the reference value and determines whether the calculated chrominance is less than the reference value.

If the analyzed similarity is greater than or equal to the reference value (“YES” in operation 430), the segment generating unit 240 allocates the peripheral pixel 332, 333, 334, . . . , or 339 to the segment containing the seed pixel 331 (operation 440). Accordingly, the segment containing the seed pixel 331 is enhanced, thereby generating the segment containing the seed pixel 331 and the peripheral pixel 332, 333, 334, . . . , or 339.

If the analyzed similarity is less than the reference value (“NO” in operation 430), the chrominance calculating unit 220 calculates the similarity between color information of the peripheral pixel 332, 333, 334, . . . , or 339 and color information of the segment close to the peripheral pixel 332, 333, 334, . . . , or 339 (operation 450).

Referring to FIG. 3D, the chrominance calculating unit 220 calculates the similarity between color information of a peripheral pixel 346 and color information of the segment 342 close to the peripheral pixel 346 and the similarity between the color information of the peripheral pixel 346 and color information of the segment 344 close to the peripheral pixel 346 (operation 450).

Here, reference numeral 346 denotes a peripheral pixel which is not contained in any segment when operation 440 is performed on all the sub images. In addition, the color information of the segment 342 or 344 may represent a mean pixel value of all the pixels.

After operation 450, the segment generating unit 240 finds segment 342 or 344 having a maximum similarity and allocates the peripheral pixel 346 to segment 342 or 344 (operation 460).

Operations 450 and 460 may be performed on all the sub images after operation 440.

The segment generating unit 240 provides the segments generated in the operation 440 and operation 460 to the initial component model generating unit 130 through an output terminal OUT3.

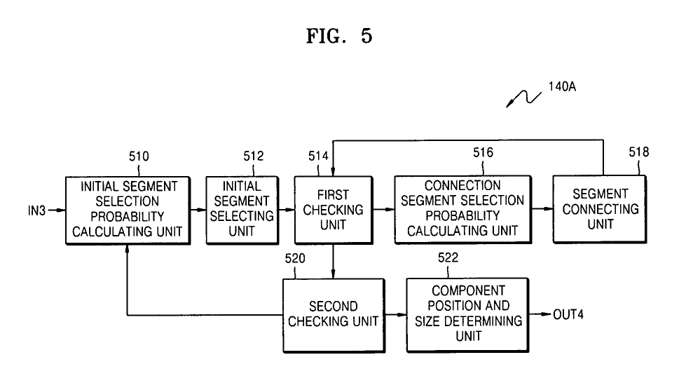

FIG. 5 is a block diagram illustrating an example 140A of the hypothesis generating unit 140 illustrated in FIG. 1. The hypothesis generating unit 140A includes an initial segment selection probability calculating unit 510, an initial segment selecting unit 512, a first checking unit 514, a connection segment selection probability calculating unit 516, a segment connecting unit 518, a second checking unit 520, and a component position and size determining unit 522.

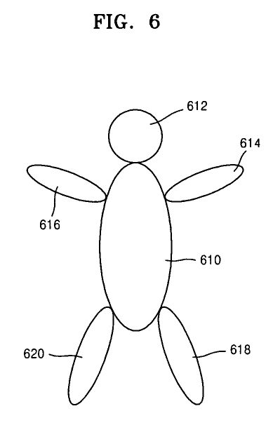

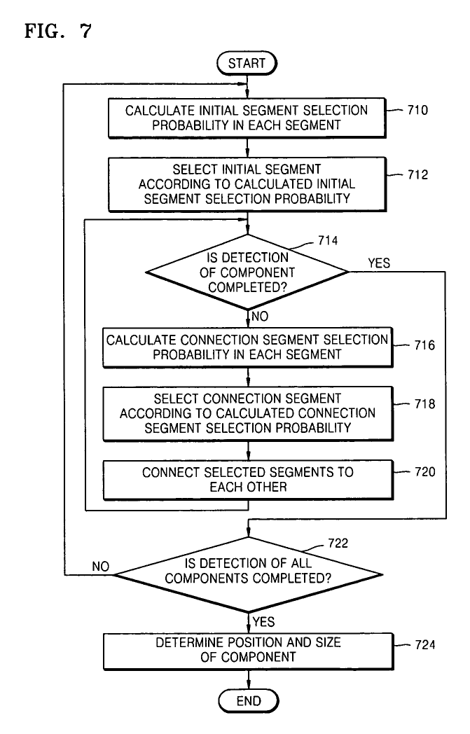

FIG. 6 is a view explaining an operation of the hypothesis generating unit 140 illustrated in FIG. 1, and FIG. 7 is a flowchart illustrating the operation of the hypothesis generating unit 140 illustrated in FIG. 1.

The operation of the hypothesis generating unit 140 will be described in detail with reference to FIGS. 5 to 7. The hypothesis generating unit 140 operates on each component, as mentioned above. Hereinafter, for convenience, it is assumed that the hypothesis generating unit 140 operates on the component C.

At this time, the component may be a body component 610, a head component 612, a left arm component 614, a right arm component 616, a left leg component 618, or a right leg component 620.

The initial segment selection probability calculating unit 510 calculates the initial selection probability P that a segment input through an input terminal IN3 is initially selected as a segment configuring the component C (operation 710). At this time, the initial segment selection probability calculating unit 510 can calculate the initial selection probability P(k) that a k^{th} segment is initially selected using Equation 2. The segment input through the input terminal IN3 may be a segment of the candidate region.

The initial segment selecting unit 512 initially selects a segment as the segment configuring the component C according to the initial selection probability P (operation 712). For example, if the initial selection probability P(k) of the k^{th} segment is 0.2, the initial segment selecting unit 512 selects the k^{th} segment with the probability of 0.2. Using such a principle, the initial segment selecting unit 512 initially selects a segment from all the segments of the candidate region as the segment configuring the component C.

The first checking unit 514 checks whether all the segments configuring the component C is selected (operation 714). For example, the first checking unit 514 checks whether a ratio of the total number of all the segments selected up to now as the segment configuring the component C to the total number of all the segments input through the input terminal IN3 is a previously set value.

For example, if the hypothesis generating unit 140 operates on the body component, that is, the hypothesis generating unit 140 selects segments configuring the body component, the first checking unit 514 checks whether all the segments configuring the body segment are selected.

In particular, the first checking unit 514 calculates a ratio of the total number of all the segments selected up to now to the total number of an image and checks whether the ratio is the previously set value.

In the checking unit 514, if it is determined that the selection of all the segments configuring the component C is not completed (“NO” in operation 714), the connection segment selection probability calculating unit 516 calculates the connection probability Pc that a peripheral segment of the initially selected segment is connected to the initially selected segment as the segment configuring the component C (operation 716).

At this time, the connection segment selection probability calculating unit 516 can calculate the connection probability Pc(I) of an l^{th} segment using Equation 3. In this case, the l^{th} segment represents a peripheral segment of the initially selected segment and the m^{th} segment represents the initially selected segment.

The segment connecting unit 518 selects the peripheral segment as the segment configuring the component C together with the initially selected segment according to the connection probability Pc (operation 718), and connects the selected peripheral segment to the initially selected segment (operation 720).

For example, if the connection probability Pc(I) that the l^{th} segment is connected to the m^{th} segment is 0.1, the segment connecting unit 518 selects the l^{th} segment with the probability of 0.1 and connects the l^{th} segment to the m^{th} segment.

After the segment connecting unit 518 connects the peripheral segment to the initially selected segment, the first checking unit 514 operates again. In other words, operation 714 is performed after operation 712 or operation 720. The first checking unit 514 determines whether all the segments configuring the component C are selected (operation 714).

Although the first checking unit 514 operates again, if it is determined that the selection of all the segments configuring the component C is not completed (“NO” in operation 714), the connection segment selection probability calculating unit 516 calculates the connection probability Pc that a peripheral segment of a latest selected segment is connected to the latest selected segment as the segment configuring the component C (operation 716). At this time, the connection segment selection probability calculating unit 516 can calculate the connection probability Pc(I) of the l^{th} segment using Equation 3. In this case, the l^{th} segment represents a peripheral segment of the latest selected segment and the m^{th} segment represents the latest selected segment.

The segment connecting unit 518 selects the peripheral segment as the segment configuring the component C together with the latest selected segment according to the connection probability Pc (operation 718), and connects the selected peripheral segment to the latest selected segment (operation 720). Then, the first checking unit 514 operates again (i.e, the process returns to operation 714).

For example, if the connection probability Pc(I) that the l^{th} segment is connected to the m^{th} segment is 0.1, the segment connecting unit 518 selects the l^{th} segment with the probability of 0.1 and connects the l^{th} segment to the m^{th} segment.

In the first checking unit 514, if it is determined that the selection of all the segments configuring the component C is completed (“YES” in operation 714), the second checking unit 520 determines whether the selection of the segments in all the components is completed (operation 722).

For example, the second checking unit 520 checks whether at least one segment configuring the body component 610, at least one segment configuring the head component 612, at least one segment configuring the left arm component 614, at least one segment configuring the right arm component 616, at least one segment configuring the left leg component 618, and at least one segment configuring the right leg component 620 are all selected.

For example, in operation 722, if it is determined that the selection of the segments of the components 610, 612, 614, 616, and 618 is completed, but the selection of the segment of the right leg component 620 is not completed, operation 710 is performed. Accordingly, the initial segment selection probability calculating unit 510 operates on the right leg component 620.

In operation 722, if it is determined that the selection of the segments of all the components 610, 612, 614, 616, 618, and 620 is completed, the component position and size determining unit 522 determines all the segments configuring all the components 610, 612, 614, 616, 618, 620 as the component model (operation 724) and outputs the determined component model through an output terminal OUT4.

In this case, the component model is composed of a plurality of components and each component is composed of at least one segment integrated by the selection and the connection. In other words, each component is defined by at least one segment and thus has an absolute position and an absolute size.

As mentioned above, the apparatus for detecting the person according to the present embodiment includes N agents. When the N agents operate in parallel, the component position and size determining unit 522 outputs N component models.

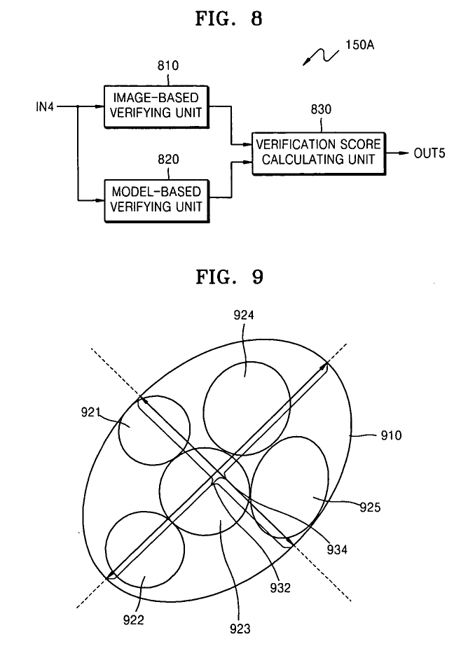

FIG. 8 is a block diagram illustrating an example 150A of the hypothesis verifying unit 150 illustrated in FIG. 1. The hypothesis verifying unit 150 includes an image-based verifying unit 810, a model-based verifying unit 820, and a verification score calculating unit 830.

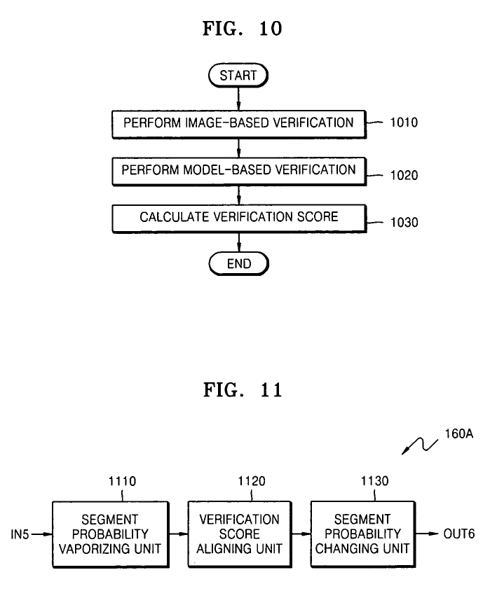

FIG. 9 is a view explaining an operation of the hypothesis verifying unit 150 illustrated in FIG. 1, and FIG. 10 is a flowchart illustrating the operation of the hypothesis verifying unit 150 illustrated in FIG. 1.

Hereinafter, the operation of the hypothesis verifying unit 150 will be described in detail with reference to FIGS. 8 to 10.

The image-based verifying unit 810 verifies whether a component model input through an input terminal IN4 is “a person to be detected” using color information of the input component model and color information of the background region (operation 1010).

The component model input through the input terminal IN4 represents the component model output through the output terminal OUT3 of FIG. 2. Accordingly, the component input through the input terminal IN4 is composed of a plurality of component having an absolute position and an absolute size and N component models may be input.

In particular, the image-based verifying unit 810 verifies that the input component model is the person to be detected when the similarity between two pieces of color information of two segments is high and the similarity between the color information of the component and the color information of the background region is low.

Accordingly, the image-based verifying unit 810 may calculate at least one of the similarity between the two pieces of color information of the integrated two segments and the dissimilarity between the color information of the integrated segments and the color information of the background segment.

The model-based verifying unit 820 compares the component model input through the input terminal IN4 with the parameter Tc and verifies whether the input component model is the person to be detected (operation 1020).

Accordingly, the model-based verifying unit 820 compares an ellipse of each of the components configuring the input component model with an ellipse defined by the parameter Tc. In particular, the model-based verifying unit 820 calculates a major axis 934 and a minor axis 932 of the component 910 defined by the integrated segments 921, 922, 923, 924, and 925 and compares a ratio between the axes 932 and 934 932 with a ratio defined by the parameter Tc.

Alternatively, the model-based verifying unit 820 may compare a ratio between sizes of the components configuring the input component model with the ratio defined by the parameter Tc. Furthermore, the model-based verifying unit 820 may compare a relative position of one component configuring the input component model against another component with a position defined by the parameter Tc.

Operation 1020 may be performed before operation 1010 or simultaneously performed with operation 1010.

The verification score calculating unit 830 calculates a verification score in correspondence with at least one of the result obtained by the image-based verifying unit 810 and the result obtained by the model-based verifying unit 820 and transmits the calculated verification score to the segment probability updating unit 160 of FIG. 2 through an output terminal OUT5 (operation 1030).

In particular, the verification score calculating unit 830 determines whether a similarity between the two pieces of color information of two integrated segments is greater than or equal to a first threshold value, whether a dissimilarity between the color information of the integrated segments and the color information of the background segment is greater than or equal to a second threshold value, whether a similarity between a ratio between the axes 934 and 932 and the ratio defined by the parameter Tc is greater than or equal to a 3-1^{th} threshold value, whether a similarity between the ratio between the sizes of the components and the ratio defined by the parameter Tc is greater than or equal to a 3-2^{th} threshold value, or whether a similarity between the relative position of one component against another component and the position defined by the parameter Tc is greater than or equal to a 3-3^{th} threshold value, and calculates the verification score based on the determined result.

The verification score is large when the similarity between the two pieces of color information of the two integrated segments is greater than or equal to the first threshold value, the dissimilarity between the color information of the integrated segments and the color information of the background segment is greater than or equal to the second threshold value, the similarity between a ratio between the axes 934 and 932 and the ratio defined by the parameter Tc is greater than or equal to the 3-1^{th} threshold value, the similarity between the ratio between the sizes of the components and the ratio defined by the parameter Tc is greater than or equal to the 3-2^{th} threshold value, or the similarity between the relative position of one component against another component and the position defined by the parameter Tc is greater than or equal to the 3-3^{th} threshold value. Here, the first, second, 3-1^{th}, 3-2^{th}, and 3-3^{th} threshold values may be previously set and changed later.

The larger the verification score, the higher the possibility that the input component model is recognized as the person. Accordingly, the verification score calculating unit 830 calculates the degree that the input component model can be recognized as the person.

As mentioned above, the apparatus for detecting the person according to the present embodiment includes N agents. When the N agents operate in parallel, the verification score calculating unit 830 calculates the verification scores of the N component models.

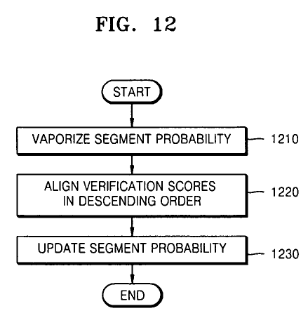

FIG. 11 is a block diagram illustrating an example 160A of the segment probability updating unit 160 illustrated in FIG. 1. The segment probability updating unit 160 includes a segment probability vaporizing unit 1110, a verification score aligning unit 1120, and a segment probability changing unit 1130.

The segment probability vaporizing unit 1110 receives the initial selection probability P and the connection probability Pc through an input terminal IN5 and reduces the initial selection probability P or the connection probability Pc by a specified ratio. For example, if the initial selection probability P(k) that the k^{th} segment is initially selected is 0.1, the connection probability Pc(I) that the l^{th} segment is connected to the m^{th} segment is 0.2, and the specified ratio is 0.95, the segment probability vaporizing unit 1110 subtracts 0.1*0.95 from the initial selection probability P(k) or subtracts 0.2*0.95 from the connection probability Pc(I). In other words, the segment probability vaporizing unit 110 reduces the segment probability Cc to reduce the initial selection probability P and the connection probability Pc. This subtraction corresponds to vaporization of pheromone stained on the path by ants over time in the ACO algorithm. Accordingly, it is represented that the segment probability vaporizing unit 1110 vaporizes the segment probability Cc.

The verification score aligning unit 1120 aligns the verification scores calculated by the verification score calculating unit 830 in the descending order and the segment probability changing unit 1130 increases the segment probability Cc in proportion to the calculated verification score.

For example, if the model generating unit 140 generates 5 component models by 5 agents (N=5) and the verification scores of the component models are 30, 90, 80, 50, and 60, respectively, the verification score aligning unit 1120 aligns the verification scores in the order of 90, 80, 60, 50, and 30.

In this case, the segment probability changing unit 1130 increases P_{rc}(r, rᵢ) and Pᵣₐ(r, C) in proportion to the verification score. For example, 1.02 is added to P_{rc}(r, rᵢ) and Pᵣₐ(r, C) of the component model having the verification score of 90, 1.005 is added to P_{rc}(r, rᵢ) and Pᵣₐ(r, C) of the component model having the verification score of 80, 1.001 is added to P_{rc}(r, rᵢ) and Pᵣₐ(r, C) of the component model having the verification score of 60, 1 is added to P_{rc}(r, rᵢ) and Pᵣₐ(r, C) of the component model having the verification score of 50, and 1 is added to P_{rc}(r, rᵢ) and Pᵣₐ(r, C) of the component model having the verification score of 30.

Accordingly, as the update is repeated, the initial selection probability P and the connection probability Pc which allows the segment configuring the component model which is not suitable for the person to be detected to be selected gradually decreases. Similarly, as the update is repeated, the initial selection probability P and the connection probability Pc which allows the segment configuring the component model suitable for the person to be detected to be selected gradually increases.

The segment probability changing unit 1130 provides the updated initial selection probability P and connection probability Pc to the hypothesis generating unit 140 through an output terminal OUT6.

FIG. 12 is a flowchart illustrating an operation of the segment probability updating unit 160 illustrated in FIG. 1, which includes operations 1210 to 1230 of vaporizing the segment probability, updating the segment probability in correspondence with the verification score, and updating the segment probability, respectively.

Referring to FIGS. 11 and 12, the segment probability vaporizing unit 1110 reduces the segment probability Cc with a specified ratio (operation 1210). If the apparatus for detecting the person according to the present embodiment includes N agents, the segment probability vaporizing unit 1110 reduces the segment probabilities Cc of the N components models with the specified ratio.

After operation 1210, the verification score aligning unit 1120 aligns the N verification scores calculated by the verification score calculating unit 830 of FIG. 8 in the descending order (operation 1220). If the apparatus for detecting the person according to the present embodiment does not include N agents, operation 1220 may not be provided.

After operation 1210 or 1220, the segment probability changing unit 1130 updates the segment probability Cc in correspondence with the verification score (operation 1230).

Embodiments of the present invention include computer readable codes on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to an apparatus and method of detecting a person according to the above-described embodiments of the present invention, by calculating a degree that a plurality of components formed by integrating at least one segment selected according to an initial selection probability and a connection probability can be recognized as a person, updating the initial selection probability and the connection probability in correspondence with the degree, and repeating the update the person can be accurately detected from a given image at a high speed. Furthermore, according to an apparatus and method of detecting a person of the present invention, since a seed pixel is specified, a peripheral pixel of the seed pixel is contained in a segment containing the seed pixel, and the segment is enhanced, the person can be more rapidly detected.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for detecting a person comprising:
a segmentation unit which analyzes plural pieces of color information of a plurality of pixels configuring a given image and generates at least one segment by grouping at least one of the pixels having a specified similarity among the plural pieces of color information;
a hypothesis generating unit which initially selects a segment in each component of the given image according to an initial selection probability that a segment is initially selected, selects an additional segment in each component according to a connection probability that the additional segment is connected to a previously selected segment, and connects the selected additional segment to the previously selected segment;
a hypothesis verifying unit which calculates a degree that a plurality of components formed by integrating the selected segments can be recognized as the person and determines that the plurality of the components is the person to be detected in response to the calculated result; and
a segment probability updating unit which updates the initial selection probability and the connection probability in correspondence with the calculated degree.

2. The apparatus of claim 1, wherein the initial selection probability is proportional to at least one of a dissimilarity between color information of the segment and color information of a background segment and a probability that the segment belongs to its component.

3. The apparatus of claim 1, wherein the connection probability is proportional to at least one of a similarity between color information of the additional segment and color information of the previously selected segment, a dissimilarity between color information of the additional segment and color information of a background segment, a probability that the additional segment is connected to the previously selected segment, and a probability that the additional segment belongs to its component.

4. The apparatus of claim 1, wherein the hypothesis verifying unit verifies at least one of whether a similarity between two pieces of color information of two integrated segments is greater than or equal to a first threshold value, whether a dissimilarity between color information of the integrated segment and color information of a background segment is greater than or equal to a second threshold value, and a similarity between the plurality of components and a specific model is greater than or equal to a third threshold value.

5. The apparatus of claim 4, wherein the hypothesis verifying unit verifies at least one of whether a similarity between a shape of each of the components and a shape of a specific ellipse is greater than or equal to a 3-1^{th} threshold value, whether a similarity between a ratio between the sizes of the components and a specified ratio is greater than or equal to a 3-2^{th} threshold value, and a similarity between a relative position of one component against another component and a specified position is greater than equal to a 3-3^{th} threshold value.

6. The apparatus of claim 1, wherein the segment probability updating unit increases the initial selection probability and the connection probability in proportion to the calculated degree.

7. The apparatus of claim 1, wherein the hypothesis generating unit, the hypothesis verifying unit, and the segment probability updating unit operate N times, N being an integer greater than or equal to 2, in parallel, and
wherein the hypothesis verifying unit calculates the degrees of N component models, and the segment probability updating unit updates N initial selection probabilities and N connection probabilities in correspondence with the calculated degrees.

8. The apparatus of claim 7, wherein the segment probability updating unit increases each of n initial selection probabilities, n being an integer of 1≦n≦N, and each of n connection probabilities in proportion to each of the n calculated degrees.

9. The apparatus of claim 1, wherein the segment probability updating unit comprises:
a segment probability vaporizing unit which reduces the initial selection probability and the connection probability with a specified ratio; and
a segment probability changing unit which updates the reduced initial selection probability and the reduced connection probability in correspondence with the calculated degree.

10. The apparatus of claim 1, wherein the hypothesis generating unit initially operates on a body component.

11. A method of detecting a person comprising:
(a) analyzing plural pieces of color information of a plurality of pixels configuring a given image and generating at least one segment by grouping at least one of the pixels having a specified similarity among the plurality pieces of color information;
(b) initially selecting a segment in each component of the given image according to an initial selection probability that a segment is initially selected, and selecting an additional segment in each component according to a connection probability that the additional segment is connected to a previously selected segment, and connecting the selected additional segment to the previously selected segment;
(c) calculating a degree that a plurality of components formed by integrating the selected segments can be recognized as the person and determining whether the calculated degree is greater than or equal to a specified value;
(d) determining that the plurality of components is the person to be detected when the calculated degree is greater than or equal to the specified value; and
(e) updating the initial selection probability and the connection probability in correspondence with the calculated degree and returning to operation (b) when the calculated degree is less than the specified value.

12. The method of claim 11, wherein operation (a) comprises:
(a11) dividing the image into a plurality of sub images and specifying a pixel in each of the sub images;
(a12) analyzing a similarity between color information of the specified pixel and color information of a pixel which is not specified and determining whether the analyzed similarity is greater than or equal to a reference value; and
(a13) allocating the pixel which is not specified to a segment containing the specified pixel when the analyzed similarity is greater than or equal to the reference value; and
wherein operations (a12) and (a13) are performed for each of the sub images.

13. The method of claim 12, wherein operation (a) further comprises:
(a14) calculating a similarity between color information of the at least one segment close to the segment and color information of the pixel which is not specified when the analyzed similarity is less than the reference value; and
(a15) allocating the pixel which is not specified to the segment having a maximum similarity in operation (a14),
wherein operations (a12) to (a15) are performed for each of the sub images.

14. The method of claim 11, wherein operation (b) is initially performed on a body component.

15. The method of claim 11, wherein the initial selection probability is proportional to at least one of a dissimilarity between color information of the segment and color information of a background segment and a probability that the segment belongs to its component.

16. The method of claim 11, wherein the connection probability is proportional to at least one of a similarity between color information of the additional segment and color information of the previously selected segment, a dissimilarity between color information of the additional segment and color information of a background segment, a probability that the additional segment is connected to the previously selected segment, and a probability that the additional segment belongs to its component.

17. The method of claim 11, wherein operation (c) comprises calculating a similarity between two pieces of color information of two integrated segments and determining whether the calculated similarity is greater than or equal to a first threshold value,
operation (d) comprises determining the plurality of components as the person to be detected when the calculated similarity is greater than or equal to the first threshold value, and
operation (e) comprises updating the initial selection probability and the connection probability in correspondence with the calculated similarity when the calculated similarity is less than the first threshold value and returning to operation (b).

18. The method of claim 11, wherein operation (c) comprises calculating a dissimilarity between color information of the integrated segment and color information of a background segment and determining whether the calculated dissimilarity is greater than or equal to a second threshold value,
operation (d) comprises determining the plurality of components as the person to be detected when the calculated dissimilarity is greater than or equal to the second threshold value, and
operation (e) comprises updating the initial selection probability and the connection probability in correspondence with the calculated dissimilarity when the calculated dissimilarity is less than the second threshold value and returning to operation (b).

19. The method of claim 11, wherein operation (c) comprises calculating a similarity between the plurality of components and a specified model and determining whether the calculated similarity is greater than or equal to a third threshold value,
wherein operation (d) comprises determining that the plurality of components is the person to be detected when the calculated dissimilarity is greater than or equal to the third threshold value, and
wherein operation (e) comprises updating the initial selection probability and the connection probability in correspondence with the calculated similarity when the calculated similarity is less than the third threshold value and proceeding to operation (b).

20. The method of claim 11, wherein operations (b) and (c) are performed N times, N being an integer greater than or equal to 2, in parallel,
wherein, in operation (c), the degrees of N component models are calculated, and
wherein, in operation (e), N initial selection probabilities and N connection probabilities are updated in correspondence with the calculated results.

21. The method of claim 11, wherein in operation (e), the initial selection probability and the connection probability are increased in proportion to the calculated degree.

22. The method of claim 11, wherein operation (e) comprises:
(e1) reducing the initial selection probability and the connection probability with a specified ratio; and
(e2) updating the reduced initial selection probability and the reduced connection probability in correspondence with the calculated degree.

23. A computer-readable medium having embodied thereon a computer program for performing a method of detecting a person, the method comprising:
(a) analyzing plural pieces of color information of a plurality of pixels configuring a given image and generating at least one segment by grouping at least one of the pixels having a specified similarity among the plurality pieces of color information;
(b) initially selecting a segment in each component of the given image according to an initial selection probability that a segment is initially selected, and selecting an additional segment in each component according to a connection probability that the additional segment is connected to a previously selected segment, and connecting the selected additional segment to the previously selected segment;
(c) calculating a degree that a plurality of components formed by integrating the selected segments can be recognized as the person and determining whether the calculated degree is greater than or equal to a specified value;
(d) determining that the plurality of components is the person to be detected when the calculated degree is greater than or equal to the specified value; and
(e) updating the initial selection probability and the connection probability in correspondence with the calculated degree and returning to operation (b) when the calculated degree is less than the specified value.

24. A method of detecting a person, the method comprising:
analyzing color information of a plurality of pixels of a candidate region of a given image where a person is expected to be, groups pixels having a specified similarity, and generates at least one segment;
generating a generated component model which can be detected as the person by initially selecting a segment in each component according to an initial selection probability, selecting a second segment in each component according to a connection probability that the second segment is connected to a previously selected segment, and connecting the second selected segment to the previously selected segment;
calculating a degree that the generated component model can be recognized as the person and verifying whether the component model is the person to be detected in response to the calculated result; and
updating the initial selection probability and the connection probability based on the verification result when the calculated degree is less than a specified threshold and returning to the segmenting.

25. The method of claim 24, wherein generated component model includes a plurality of segment-based components.
